(19) United States
(12) Patent Application Publication
(10) Pub. No.: US 2012/0323813 A1
(43) Pub. Date: Dec. 20, 2012

(54) Integrated Portal Based Comprehensive Management of Delivery of Public Services

(76) Inventor: Pankaj Phadnis, Mumbai (IN)

(21) Appl. No.: 13/580,182

(22) PCT Filed: Feb. 21, 2011
(86) PCT No.: PCT/IB2011/000329

§ 371 Date: Aug. 21, 2012

(30) Foreign Application Priority Data
Feb. 23, 2010 (IN) 69/MUM/2010

(51) Int. Cl. G06Q 50/20

(52) U.S. Cl. 705/326

(57) ABSTRACT

A system for improved management of delivery of education/educational services, said system comprising plurality of integrated modules comprising curriculum mapping module comprising providing portion of a specific curriculum to be covered for every subject in every school day of a year defining a unit; wherein said module further comprising multi-media means for recording plurality of said unit and uploading the units in a server means on the module; delivery and reporting module connecting an individual student or a group of students by means of web cams and microphone means over an interne network means adapted to have bi-directional interaction with a teacher or group of teachers; communication and collaboration module comprising plurality of bulletin sections having means for material evaluation and transfer any relevant information between the bulletin sections; bulletin module means for posting views/issues and directing them to responsible for addressing said view/issue; and management information module being uploaded with parameters decided by system owner in terms of issues such that said module designed appropriately with information hierarchy such that data mining is possible for an individual school and/or student.

### FIELD OF THE INVENTION

The present invention relates to an Integrated Portal Based Comprehensive Management of Delivery of Public Services. More particularly, the invention is concerned about a system for certain methods and processes embedded in central servers in respect of an interne enabled portal for the purpose of empowering, communicating, collaborating, training and online MIS (Management Information System) based recording of transactions on the eco system of the Portal.

The present embodiment addresses a system and a method for improving delivery of educational service. However, the system and the method can be used for improving any Public service particularly in the focus areas of Health Care including Sports, Education and Food Security.

### BACKGROUND OF THE INVENTION

U.S. Pat. No. 6,804,654 discloses an automated prescription transcription and dispatch service using voice recognition and a customizable, user-friendly telephony interface is provided. A doctor or other medical personnel can call a prescription services system, and provide spoken prescription information. The call can be placed directly to the prescription services system using the Public Switched Telephone Network (PSTN) or Voice-over-IP (VoIP) connection, or can be forwarded to the prescription services system from a telephone number corresponding to a pharmacy. The system prompts the user through audible menus to provide prescription and patient information. The spoken information is digitized, recorded, and stored in the prescription services system, and then transcribed into textual format. The transcribed prescriptions are then transmitted to the doctor or medical personnel via variety of communication methodologies, such as fax, e-mail, XML, and electronic data interchange, for confirmation, review, and record keeping purposes. Further, the transcribed prescriptions are transmitted to a pharmacy, using similar communication methodologies, for review and further processing. The caller can call the prescription services system to review the spoken and transcribed prescription information stored from a previous session. The prescription services system can be integrated into existing pharmacy management systems using electronic data interchange (EDI) and other data exchange protocols.

U.S. Pat. No. 6,859,783 discloses a system and method for opening and tracking trouble tickets over the public Internet. A customer service management system provides information included within a customer profile record to a Web enabled infrastructure which is accessible by a remote customer workstation having a web browser and Internet access. The customer profile information is used to prepopulate data fields in dialogs used to open a trouble ticket. Once a trouble ticket is opened, the customer workstation tracks the existing trouble tickets through a browser based graphical user interface. The graphical user interface provides current and historical status reports of the actions taken to resolve a network event and the service organizations responsible for resolving the network event.

Governments around the World particularly in the Developing Countries struggle to make the delivery of their public services friendly and efficient for the intended beneficiaries. Availability of funds or lack thereof is often cited as the prime reason but that is simply not consistent with facts.

For example by 2009, while conducting a study on the delivery of public services in a country despite of massive expenditure, the position in respect of the Goal of Education For All as reported on Sep. 9, 2009 for Delivery Monitoring Unit (DMU) of the Prime Minister's Office is as under:

| Goal | Status 2009 |
|---|---|
| Universal Enrolment by 2003 | 8,000,000 children remain out of |
| | school |
| Five Years of education for all by 2007 | 50,000,000 drop out before |
| | Grade V |
| Eight Years of education for all by 2010 | 100,000,000 drop out before |
| | Grade VIII |

The reasons for this unacceptable status are Single Teacher Schools about 114,531, Schools without drinking water, which are about 165,472 and schools without common toilet about 455, 561, which affect particularly the Girl Child.

It has been found that current Management Information System (MIS) captures information with a considerable time lag and has no provision to capture information about an individual student. The Policy Makers are therefore deprived of the capability of timely intervention to make a difference.

A doctoral study undertaken by the present inventor identifies the need to address the following problem areas:
Poor Quality of Teaching Material
Lack of opportunity for the Students Learn at their Own Pace
Inadequate facilities for Quality upgradation of Teachers
Community having little or No Say in the Process of Education Delivery

Governments are often faulted for not spending enough monies say as % of the GDP on Health including Sports, Education and Food security. Important as it is for ensuring that sectors like Health, Education and Food Security get the importance they deserve, it is equally more important to ensure that whatever is being spent is being spent fruitfully.

For instance, the Government of India plans to spend some US $35 billion or over Rs 170,000 crores in next five years to ensure that the Goal of Education for All (EFA) is met and Right to Life is protected for some 200 million eligible students in the age group of 5 to 14.

A project of this magnitude needs to be supported by world class MIS as can be seen from the comparison given below

| Current MIS | World Class MIS |
|---|---|
| At the School Level | At the Individual Level |
| Basis for key information such | Key information should be |
| as Enrolment - sample survey | based on actual headcount |
| Dated (2006/07 or 2007/08) for | On Line |
| 2009 reports | |
| Key Information missing | Key Information such as |
| | Attendance record/ |
| | Malnourishment status/ |
| | Academic record etc |
| | should be captured |

In addition to modern MIS, there is a compelling case for an Information and Communication Technology (ICT) intervention to facilitate resolution of key bottlenecks in the delivery of education by:
Providing web based curriculum content so that best of the breed teaching material is available uniformly to all teachers and specially benefit single teacher schools or schools where a single Teacher has to teach subjects as diverse as Languages (two or more) and Science along with History and Geography
A help line cell with two way video, audio interaction between students and remotely based teachers so that students who can not afford private coaching classes can also learn at their own place.
A portal based interaction between teachers do that quality upgradation takes place by peer level interaction
An e mail facility to students and their parents so that the community can have a say in the delivery of education.

In other words, there is a need for an integrated One Stop IT enabled product using latest advances in Information and Communication Technology to aid the efforts of the Government of a country for Universalization of Education.

The present inventor has found that the problems of the prior art can be overcome by a system uniquely designed for certain methods and processes embedded in central servers in respect of an interne enabled portal for the purpose of empowering, communicating, collaborating, training and online MIS (Management Information System) based recording of transactions on the eco system of the Portal. The record of these transactions is maintained in an information hierarchy that facilitates data mining from the highest level of the aggregate information down to the lowest level. The capture of data is at the level of Individual which provides a very accurate and precise information of the delivery of services to the public.

The system of the present invention uses latest advances in Information and Communication Technology together efficient business processes designed to offer a comprehensive solution to Public bodies wishing to improve the delivery of their public services and runs on an appropriate software. The first application is in the area of Education.

However, the tool is designed with flexibility required to respond to similar needs of improving delivery of other public services such as Health Care including Sports and Food Security. Indeed, it can integrate the requirements of Health Care including Sports, Education and Food Security thereby addressing issues of Women and Children comprehensively.

### OBJECTS OF THE INVENTION

A basic object of the present invention is to overcome the drawbacks of the prior art.

Another object of the present invention is to provide a system for certain methods and processes embedded in central servers in respect of an interne enabled portal for the purpose of empowering, communicating, collaborating, training and online MIS (Management Information System) based recording of transactions on the eco system of the Portal.

Another object of the present invention is to provide a method for empowering, communicating, collaborating, training and online MIS (Management Information System) based recording of transactions on the eco system of the Portal.

Another object of the present invention is to provide an information hierarchy for facilitating data mining from the highest level of the aggregate information down to the lowest level.

### SUMMARY OF THE INVENTION

According to one aspect of the present invention there is provided a system for improved management of delivery of education/educational services, said system comprising plurality of integrated modules comprising:

Curriculum mapping module comprising providing portion of a specific curriculum to be covered for every subject in every school day of a year defining a unit; wherein said module further comprising multi-media means for recording plurality of said unit and uploading the units in a server means on the module;

Delivery and reporting module connecting an individual student or a group of students by means of web cams and microphone means over an internet network means adapted to have bi-directional interaction with a teacher or group of teachers;

Communication and collaboration module comprising plurality of bulletin sections having means for material evaluation and transfer any relevant information between the bulletin sections;

Bulletin module means for posting views/issues and directing them to responsible for addressing said view/issue; and

Management information module being uploaded with parameters decided by system owner in terms of issues such that said module designed appropriately with information hierarchy such that data mining is possible for an individual school and/or student.

### DESCRIPTION OF THE PRESENT INVENTION

The present invention is in respect of a system for certain methods and processes embedded in central servers in respect of an internet enabled portal for the purpose of empowering, communicating, collaborating, training and online MIS (Management Information System) based recording of transactions on the eco system of the Portal. Every transaction in the eco system is logged in the Relational Database Management System (RDBMS) residing on the central servers. The record of these transactions is maintained in an information hierarchy that facilitates data mining from the highest level of the aggregate information down to the lowest level. The capture of data is at the level of Individual.

The said systems and processes are delivered to remote clients connected to the central server via the Internet. These systems and processes empower the community/general public by giving them a ‘voice that can be heard’ in respect of delivery of public service, the receipt of which is a matter of right. Communication and Collaboration amongst the agents of delivery of services is effected by enabling an interaction of the views and feedback of persons concerned across geographies and even time zones. The training of both the agents of delivery of services and the recipients of the services is facilitated by the availability of best breed of online material. An opportunity is also provided whereby one can access and receive feed back from even remotely located experts.

The system is controlled and worked upon by:
(a) Moderator, which is responsible for scanning the available information in the eco system of the Portal and ensuring that only such material is available for access, which meets the parameters set by the system owner.
(b) Controller, which is responsible for ensuring that issues remaining unresolved beyond the time frame set by system owner are directly sent to the relevant decision makers.

The System therefore not only promotes individual welfare through improved services but also captures in real time the impact of the services on the target customer of the services by enabling necessary course correction.

The invention is capable of effective a paradigm shift in the delivery of public services in the area of health including sports, education and food security and thus facilitate attainment of UN Millennium Development Goals in this respect and thereby improve the Human Development Index of the community in which it is deployed.

Information communications technology tools required in the present invention are:
Biometrics Machines
Personal Computers
Printers
Projector Screens
Broadband Connectivity
Web Cams and Microphones for Two way Interactions
Central/Regional Servers for hosting the Portal
Relational Data Base Management Systems (RDBMS)
Software

The heart of this integrated Portal is Relational Data Base Management System (RDBMS) residing on a Central Server which will capture every transaction on any Module of the Portal. The capture will either be directly on the central server or via a group of regional servers depending on the System architecture chosen.

All other ICT tools are necessary to support the technical features of the invention defined hereinafter.

The invention is designed to cover number of public access points of public services delivery not within easy daily commuting distance of each other. The coverage can technically be extended to as large an area as is administratively required.

It addresses the issue of improving delivery of public service by promoting Empowerment, Communication and Collaboration, Training and Transaction recording. The principle feature is an generation of On Line MIS to help Policy Makers drive the process of implementation of the delivery process.

In this instance, the system of the present invention has three distinct features that alone operated in synergistic manner facilitate attainment of the desired results. These three features are:
Technical Features supported by Software
Embedding of the System in a Central Data Centre
Business Processes

Details of each are given below

### Technical Features

As noted earlier the technical features described hereinbelow explain the manner in which system of the present invention can facilitate improvement in delivery of Education. It can also be seen that a similar approach using the same features will also facilitate the improvement in delivery of public services in other areas such as Health Care including Sports and Food Security

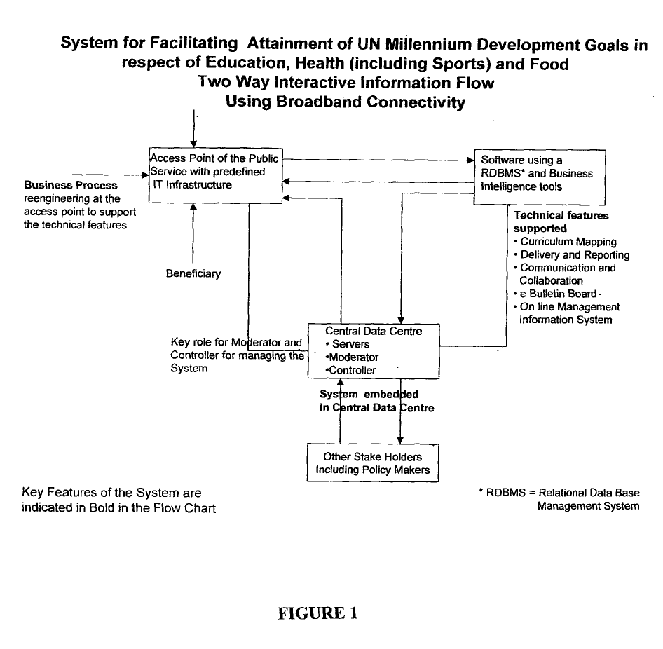

### Module I: Curriculum Mapping (Shown in the Flow Chart of FIG. 1)

An annual Calendar will be drawn up giving portion of the curriculum to be covered for every subject in every School Day of the year. Each period of the school day will be considered as one unit.

A video recording/animated film for each unit will be made using latest multi-media tools using the best possible teacher as if she was taking the Class on a live basis. This will be in two parts. Part One will be multi media portion explaining the concepts. Part two will be the full recording of the Unit including the Multi media part. Part One will be limited to 25% of the available time of the duration of the class. Part Two will be limited to 75% of the available time of the duration of the class

All Units for all the Classes will be uploaded on the Module. RDBMS on the Central server will keep a log of the nature and frequency Download activity

The concerned teacher will have of using the option of using the Part One or Part Two. In either case, the Teacher will have the time (at least 25% time) to also explain to the Students on her own.

Thus while best of the breed material will be available as a Standard feature, the Teacher in the School will also have the functional ability to influence the Teaching Process at her end.

### Module II: Delivery and Reporting (Shown in the Flow Chart of FIG. 1)

This module will connect an individual student or a group of students via web cam over the Internet with a microphone to have a two way interaction with a Group of Teachers who could be available at the site of the Central or Regional Servers.

This Group of Teachers could be Professional teachers or trained volunteers willing to spend their time for a Productive Social. The tool will free them from the constraint of influencing teaching in a particular school to a number of schools across the entire geography of the coverage of the Tool.

The Module will enable the Students in every school covered by the Tool to have a fall back option at a time convenient to them to catch up on topics they may have missed due to their/teacher absence.

This will facilitate Learning at Own Pace of the Student.

The Students who used this Module, the time of their interaction, topics covered will be logged in the RDBMS.

### Module III: Communication and Collaboration (Shown in the Flow Chart of FIG. 1)

This Module aims at Upgrading the Quality Profile of the Teachers by Peer Level Interaction. A two tier Bulletin Board will be provided in the Portal as a space. Tier I will be Regional Bulletin Board. Tier II will be Central Bulletin Board. Each Tier will have Moderator to evaluate Material posted. All Teachers will be encouraged to post their own comments and inputs on the Material available on Module I and or those available on Tier I/Tier II Bulletin Board. The Teacher will have the option of using either Tier I or Tier II.

Regional Moderator will transfer relevant material from Tier I Bulletin Board to Tier II Bulletin Board. Central Moderator will be responsible for incorporating inputs into the Module I material where relevant.

Central RDBMS will maintain a log of all activities on the Bulletin Board.

Module IV: E Mail Bulletin Board (shown in the flow chart of FIG. 1)

All Students/Teachers/Administrators will be given an individual e mail id. The Student e mail ID will be used wither by the Student or her parents.

A Multi tier Bulletin Board will be provided as a space on the Portal. Any e mail ID holder will be authorized to post her view/issue on any of the tiers provided. Each Tier will be manned by a Moderator.

The Moderator will direct the e mail to the person responsible for addressing the view/issue.

The Moderator will also be responsible for escalating the issue to next Tier if it remains unresolved within a specified time frame.

E mails will remain on the Bulletin Board marked as Pending until resolved.

This will give the Stakeholders a Voice in the Delivery of Educational Services

Central RDBMS will keep a log of the e mails received, inputs received and time taken for resolutions of issues raised.

### Module V: on Line MIS for Policy Makers (Shown in the Flow Chart of FIG. 1)

Management of this Module will rest with the System Controller who will work within the parameters decided by the System owner in terms of issues that need to be reported/escalated as per a pre defined protocol.

School level MIS that is currently manually collected will be uploaded into the system. Student level MIS such as Biometric record of attendance, Nutritional Status, Educational Progress will be uploaded at the specified time intervals.

Dashboards will be created and MIS periodically sent at specified frequencies to the designated Officers responsible for the Educational Delivery.

A team of technical and functional persons shall be provided to deliver the MIS specified by the User as per a time table agreed to in advance. This team will work on a five day week for nine hours a day basis. Key MIS features will be as under:

| | |
|---|---|
| Biometrics Attendance by Student | Daily |
| Nourishment Status by Student | Quarterly |
| Academic Record by Student | Quarterly |
| School Infrastructure | Quarterly |

The MIS will be delivered normally at the aggregated level. However, there will be facility to drill down to the Individual Student/School level by designing appropriate Information Hierarchy. Thus Policy Maker at any level wishing to see the name and even photo of a student who is malnourished or is not attending school or is low in academic records, will be able to do so.

The data will therefore not be a mere statistics but get converted to information that can be acted upon.

The management system of the present invention as an IT solution can run on several platform using both proprietary data bases such as MS SQL, DB II, Oracle etc or open source data bases such as MYSQL using appropriate dot net or Java technology Furthermore, software implementations can include, but not limited to, distributed processing or component/object distributed processing, parallel processing, or virtual machine processing can also be constructed to implement the methods described herein.

eJyoti™ is the software that has been designed for supporting the technical features of the system. Though this software is used in the present system, it is not to be considered as confining the scope of the present invention. Any other software, which could support the technical features of the system of the present invention can be used and the invention can still be performed,

### Embedding of the Management System in the Central Data Centre

An essential feature of the system of the present invention is embedding of the portal in the Central servers hosted in a Data Centre which connected to by reliable and secure forms of communication to the remotely located access points of the public delivery systems. This becomes the heart of the system

The Central Data Centre is designed to ensure that remote technical monitoring of the access points can be done in real time. Absence of an ability to do so at present is the lacuna that hampers policy makers in their efforts to improve the delivery of public services

### Business Processes

Business processes make up the third leg of the triangle that form the pillars of the Invention. The first two being the Technical Features and Central Data Centre described hereinabove.
The Business Processes have three sub parts which are sought to be addressed
8.1 Collection and Input of Data in respect of Intended Beneficiaries by an appropriate manpower at the access points
8.2 Moderator located in the Central Data Centre, who is responsible for scanning the available information in the eco system of the Portal and ensuring that only such material is available for access, which meets the parameters set by the system owner.
8.3 Controller located at a point defined by the System Owner, who is responsible for ensuring that issues remaining unresolved beyond the time frame set by system owner are directly sent to the relevant decision makers.

### Advantages of the Present Invention Over Existing Systems Such as ERPs:

(a) Web Hosting of Content/e Learning tools
   These are IT tools that seek to address the Educational area which is also sought to be addressed by the system of the present invention. However, none of these tools use the concept of a central server to record transaction in order to generate MIS. Moreover, the system is also unique in the sense that it adopts a holistic approach to the issue as against a piece meal approach
(b) ERP Systems
   These IT tools use the principle of a central server to record transactions in order to generate on line MIS.
   However, these tools do not address the issue of
      Empowerment
      Collaboration
      Communication
      Training
   Though some ERP systems do have these features as an add on, the centrality of the ERP systems is to address the welfare of Shareholders in a Commercial entity.
On other hand the present system addresses the issue of collating and compiling information for protecting Right to Meaningful Life of an Individual—no matter how remotely she is located in the geography covered by the system
The uniqueness of the system rests on the design of its integrated system and form of collection and collation of information for the purpose the product is designed.

The system described with respect to the exemplary embodiments may comprise a machine or other computing device within which a set of instructions, when executed, may cause the machine to perform any one or more of the methodologies discussed above. In some embodiments, the system operates as a standalone system. In some embodiments, the system may be connected to other systems by way of internet connectivity. In a networked deployment, the system may operate in the capacity of a server or a client user system in a server-client user network environment, or as a peer system in a peer-to-peer (or distributed) network environment. The system may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single system is illustrated, the term “system” shall also be taken to include any collection of systems that individually or jointly execute a set (or multiple sets) of instructions to perform any one or more of the methodologies discussed herein.

The system may include a processor (e.g., a central processing unit (CPU), a graphics processing unit (GPU, or both), a main memory and a static memory, which communicate with each other via a bus. The system may include an input device (e.g., a keyboard) or touch-sensitive screen, a cursor control device (e.g., a mouse), a disk drive unit, a signal generation device (e.g., a speaker or remote control) and a network interface device.

The disk drive unit may include a machine-readable medium on which is stored one or more sets of instructions (e.g., software) embodying any one or more of the methodologies or functions described herein, including those methods illustrated above. The instructions may also reside, completely or at least partially, within the main memory, the static memory, and/or within the processor during execution thereof by the machine. The main memory and the processor also may constitute machine-readable media. While the machine-readable medium can be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to: tangible media; solid-state memories such as a memory card or other package that houses one or more read-only (non-volatile) memories, random access memories, or other re-writable (volatile) memories; magneto-optical or optical medium such as a disk or tape; non-transitory mediums or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

1. A system for improved management of delivery of education/educational services, said system comprising plurality of integrated modules comprising:
Curriculum mapping module comprising providing portion of a specific curriculum to be covered for every subject in every school day of a year defining a unit; wherein said module further comprising multi-media means for recording plurality of said unit and uploading the units in a server means on the module;
Delivery and reporting module connecting an individual student or a group of students by means of web cams and microphone means over an internet network means adapted to have bi-directional interaction with a teacher or group of teachers;
Communication and collaboration module comprising plurality of bulletin sections having means for material evaluation and transfer any relevant information between the bulletin sections;
Bulletin module means for posting views/issues and directing them to responsible for addressing said view/issue; and
Management information module being uploaded with parameters decided by system owner in terms of issues such that said module designed appropriately with information hierarchy such that data mining is possible for an individual school and/or student.

2. System as claimed in claim 1 wherein said multi-media means comprising providing recording of units in two parts.

3. System as claimed in claim 2 wherein said two part recording comprising multi media portion explaining the concepts.

4. System as claimed in claim 2 wherein said two part recording comprising full recording of the unit including the multi media part.

5. System as claimed in claim 1 further comprising relational database management system at the central server adapted to capture every transaction on any module.

6. System as claimed in claim 1 further comprising biometric machines.

7. System as claimed in any of the preceding claims adapted to be used for Health Care services.

8. System as claimed in any of the preceding claims adapted to be used for Sports services.

9. System as claimed in any of the preceding claims adapted to be used for Food security services.

10. System as claimed in any of the preceding claims wherein data mining is done with assistance of expert knowledge base software.

11. A system for improved management of delivery of education/educational services as herein substantially described and illustrated with reference to the accompanying drawings.
